(19) United States
(12) Patent Application Publication
(10) Pub. No.: US 2013/0214754 A1
(43) Pub. Date: Aug. 22, 2013

(54) POWER SUPPLY DEVICE

(71) Applicant: CHENG-LUNG CHIANG, New Taipei (TW)

(72) Inventor: CHENG-LUNG CHIANG, New Taipei (TW)

(21) Appl. No.: 13/676,145

(22) Filed: Nov. 14, 2012

(30) Foreign Application Priority Data
Feb. 20, 2012 (TW) 101105542

(51) Int. Cl. G05F 1/565

(52) U.S. Cl. CPC G05F 1/565
USPC 323/285

(57) ABSTRACT

A power supply device includes a power supply unit, a buck converter, a logic circuit, and a snubber circuit. The buck converter and the logic circuit are connected to the power supply unit. The buck converter is configured to convert a direct current voltage output from the power supply unit into a preset voltage supplied to an input terminal of an electronic device. The snubber circuit is electronically connected between the buck converter and the logic circuit. The power supply unit determines whether the buck converter is under a heavy load or light load. If the buck converter is under the heavy load, the power supply unit triggers the logic circuit to allow the snubber circuit to connect to ground through the logic circuit. If the buck converter is under the light load, the power supply unit triggers the logic circuit to allow the snubber circuit to disconnect from ground.

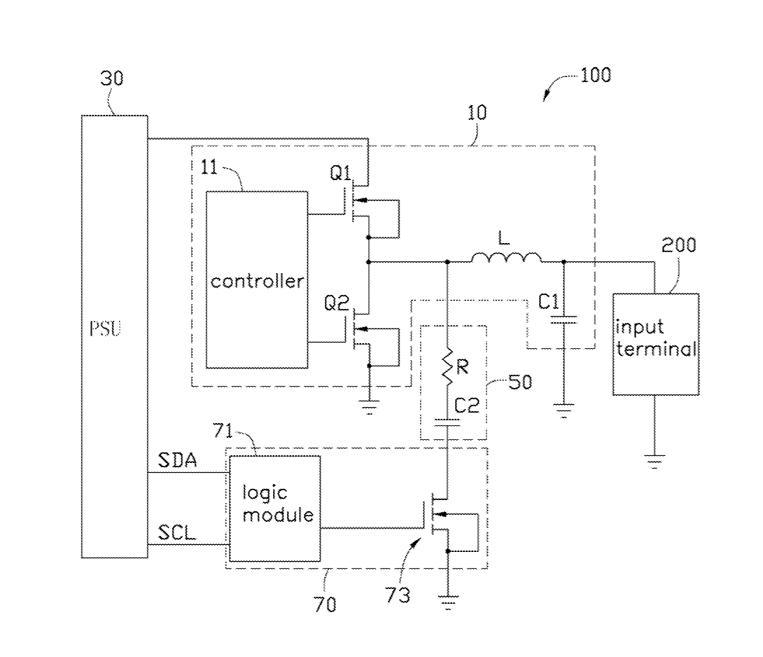

### BACKGROUND

1. Technical field

The disclosure generally relates to power supply devices, and particularly to a power supply device including a snubber circuit.

2. Description of the Related Art

A typical power supply device of electronic devices includes a power supply unit (PSU) and a buck converter. The PSU supplies direct current (DC). The buck converter converts the DC voltage of the PSU down to a preset voltage which is supplied to the electronic device. A typical buck converter includes a first switch and a second switch alternately closed and opened. When the buck converter is under a heavy load (for example, when the output voltage of the PSU is high (e.g., greater than 20 volts)), the first switch and the second switch turn on and turn off at a high frequency causing generation of a voltage spike that may damage the first switch and the second switch.

A commonly used snubber circuit includes a resistor and a capacitor connected in series, and the snubber circuit is connected in parallel with the second switch to decrease the voltage spike. However, when the buck converter is under a light load (for example, when the output voltage of the PSU is low (e.g., less than 20 volts), the snubber circuit is idle and increases the power loss of the power supply device.

Therefore, there is room for improvement within the art.

### BRIEF DESCRIPTION OF THE DRAWINGS

Many aspects of an exemplary power supply device can be better understood with reference to the following drawings. The components in the drawings are not necessarily drawn to scale, the emphasis instead being placed upon clearly illustrating the principles of the exemplary power supply device. Moreover, in the drawings, like reference numerals designate corresponding parts throughout the several views. Wherever possible, the same reference numbers are used throughout the drawings to refer to the same or like elements of an embodiment.

The FIGURE is a circuit diagram of a power supply device, according to an exemplary embodiment.

### DETAILED DESCRIPTION

Reference is now made to the FIGURE to describe one embodiment of the present disclosure in detail.

The FIGURE is a circuit of power supply device 100 of one embodiment. The power supply device supplies power to an input terminal 200 of an electronic device (not shown). The power supply device 100 includes a buck converter 10, a power supply unit (PSU) 30, a snubber circuit 50, and a logic circuit 70. The buck converter 10 and the logic circuit 70 are electronically connected to the PSU 30. The snubber circuit 50 is electronically connected between the buck converter 10 and the logic circuit 70. The PSU 30 provides a direct current voltage to the buck converter 10, and determines whether the buck converter 10 is under a heavy load or a light load. The PSU 30 stores a threshold current value, detects an input current value of the buck converter 10, and compares the input current value with the threshold current value. If the input current value is greater than the threshold current value, the buck converter 10 is under the heavy load; if the input current value is less than the threshold current value, the buck converter 10 is under the light load.

The buck converter 10 includes a controller 11, a first switch Q1, a second switch Q2, an inductor L, and a filter capacitor C1. In this embodiment, the first switch Q1 and the second switch Q2 are field-effect transistors. Gate electrodes of the first switch Q1 and the second switch Q2 are electronically connected to the controller 11. The controller 11 adjusts voltages of the gate electrodes to selectively close or open the first switch Q1 and the second switch Q2. In this embodiment, the controller 11 is a pulse width modulation integrated circuit (PWM IC) chip. The controller 11 sends pulse width modulation signals to the first switch Q1 and the second switch Q2, and adjusts duty ratio of the pulse width modulation signals to regulate turn-on time of the first switch Q1 and the second switch Q2.

The first switch Q1 and the second switch Q2 are connected in series between the PSU 30 and the ground. A drain electrode of the first switch Q1 is electronically connected to the PSU 30, and a source electrode of the first switch Q1 is electronically connected to a drain of the second switch Q2. A source electrode of the second switch Q2 is grounded. A first end of the inductor L is electronically connected to the drain electrode of the second switch Q2, and a second end of the inductor L is electronically connected to the ground through the filter capacitor C1. The input terminal 200 is connected in parallel with the filter capacitor C1. When the controller 11 allows the first switch Q1 to close (turn on), and allows the second switch Q2 to open (turn off), the PSU 30 provides power to the input terminal 200 via the first switch Q1 and the inductor L, and the inductor L stores energy in electromagnetic form. When the controller 11 allows the first switch Q1 to open (turn off), and allows the second switch Q2 to close (turn on), the inductor L acts like a voltage source and provides power to the input terminal 200.

The snubber circuit 50 includes a resistor R and a snubber capacitor C2 connected in series. The drain electrode of the second switch Q2 is connected to the resistor R. The snubber capacitor C2 is connected to the ground via the logic circuit 70.

The logic circuit 70 includes a logic module 71 and a control switch 73. In this embodiment, the logic module 71 is a gate circuit (AND gate or OR gate) and the control switch 73 is a field-effect transistor, a gate electrode of the control switch 73 is electronically connected to the logic module 71. A drain electrode of the control switch 73 is electronically connected to the snubber capacitor C2, and a source electrode of the control switch 73 is grounded. The logic module 71 communicates with the PSU 30 through a serial data (SDA) pin and a serial clock (SCL) pin of a system management bus (SMBus).

The working process of the power supply device 100 may include the following steps: the PSU 30 provides an input current to the buck converter 10, and then the controller 11 sends pulse width modulation signals to the first switch Q1 and the second switch Q2 to selectively close or open the first switch Q1 and the second switch Q2. The PSU 30 detects the input current value, and compares the input current value with the threshold current value. If the input current value is greater than the threshold current value, the buck converter 10 is under a heavy load. The PSU 30 triggers the logic module 71 to allow the control switch 73 to close. Thus, the snubber circuit 50 is connected in parallel with the second switch Q2 to decrease a voltage spike of the input current. If the input current value is less than the threshold current value, the buck converter 10 is under a light load. The PSU 30 triggers the logic module 71 to allow the control switch 73 to open. Thus, the snubber circuit 50 is disconnected from the second switch Q2 and the power loss is avoided.

The PSU 30 determines whether the buck converter 10 is under a heavy load or a light load. If the buck converter 10 is under the heavy load, the PSU 30 triggers the logic module 71 to allow the snubber circuit 50 to connect in parallel with the second switch Q2 to decrease a voltage spike. If buck converter 10 is under the light load, the PSU 30 triggers the logic module 71 to allow the snubber circuit 50 to disconnect from the second switch Q2 and the power loss is avoided.

In an alternative embodiment of the present disclosure, the PSU 30 stores a threshold voltage value, and compares an input voltage value of the buck converter 10 with the threshold voltage value to determine whether the buck converter 10 is under a heavy load or a light load.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A power supply device that supplies power to an input terminal of an electronic device, the power supply device comprising:
a power supply unit;
a buck converter electronically connected to the power supply unit and configured to convert a direct current voltage output from the power supply unit into a preset voltage and supply the preset voltage to the input terminal;
a logic circuit electronically connected to the power supply unit; and
a snubber circuit electronically connected between the buck converter and the logic circuit;
wherein the power supply unit provides the direct current voltage to the buck converter, and determines whether the buck converter is under a heavy load or a light load; if the buck converter is under the heavy load, the power supply unit triggers the logic circuit to allow the snubber circuit to be grounded through the logic circuit; if the buck converter is under a light load, the power supply unit triggers the logic circuit to allow the snubber circuit to disconnect from ground.

2. The power supply device as claimed in claim 1, wherein the power supply unit detects an input current value of the buck converter, determines that the buck converter is under the heavy load if the input current value is greater than a threshold current value, and determines that the buck converter is under the light load if the input current value is less than the threshold current value.

3. The power supply device as claimed in claim 2, wherein the logic circuit comprises a logic module electronically connected to the power supply unit and a control switch connected to the ground; the power supply unit triggers the logic module to allow the control switch to close or open; and the snubber circuit is connected to the ground via the control switch.

4. The power supply device as claimed in claim 3, wherein the logic module is a gate circuit and the control switch is a field-effect transistor; a gate electrode of the control switch is electronically connected to the logic module.

5. The power supply device as claimed in claim 3, wherein the snubber circuit comprises a resistor and a snubber capacitor connected in series; the resistor is electronically connected to the buck converter and the snubber capacitor is electronically connected to the control switch.

6. The power supply device as claimed in claim 3, wherein the buck converter comprises a controller, a first switch, a second switch, an inductor, and a filter capacitor; the first switch and the second switch are connected in series between the power supply unit and the ground; the first switch and the second switch are alternately closed and opened under control of the controller; a first end of the inductor is electronically connected to the second switch, and a second end of the inductor is electronically connected to the ground through the filter capacitor.

7. The power supply device as claimed in claim 6, wherein the first switch and the second switch are field-effect transistors, gate electrodes of the field-effect transistors are electronically connected to the controller; the controller is a pulse width modulation integrated circuit chip.

8. The power supply device as claimed in claim 7, wherein the input terminal is connected in parallel with the filter capacitor.

9. The power supply device as claimed in claim 3, wherein the logic module is communicated with the power supply unit through a serial data pin and a serial clock pin of a system management bus.

10. A power supply device for supplying power to an input terminal of an electronic device, the power supply device comprising:
a power supply unit;
a buck converter electronically connected to the power supply unit and configured to convert a direct current voltage output from the power supply unit into a preset voltage and supply the preset voltage to the input terminal;
a logic circuit electronically connected to the power supply unit, the logic circuit comprising a logic module electronically connected to the power supply unit and a control switch connected to ground; and
a snubber circuit electronically connected between the buck converter and the control switch;
wherein the power supply unit provides the direct current voltage to the buck converter, and determines whether the buck converter is under a heavy load or a light load; if the buck converter is under the heavy load, the power supply unit triggers the logic module to close the control switch and the snubber circuit is grounded through the control switch; if the buck converter is under the light load, the power supply unit triggers the logic module to open the control switch and the snubber circuit is disconnected from ground.

11. The power supply device as claimed in claim 10, wherein the power supply unit detects an input current value of the buck converter, determines that the buck converter is under the heavy load if the input current value is greater than a threshold current value, and determines that the buck converter is under the light load if the input current value is less than the threshold current value.

12. The power supply device as claimed in claim 10, wherein the logic module is a gate circuit and the control switch is a field-effect transistor; a gate electrode of the control switch is electronically connected to the logic module.

13. The power supply device as claimed in claim 12, wherein the snubber circuit comprises a resistor and a snubber capacitor connected in series; the resistor is electronically connected to the buck converter and the snubber capacitor is electronically connected to the control switch.

14. The power supply device as claimed in claim 12, wherein the buck converter comprises a controller, a first switch, a second switch, an inductor, and a filter capacitor; the first switch and the second switch are connected in series between the power supply unit and the ground; the first switch and the second switch are alternately closed and opened under the control of the controller; a first end of the inductor is electronically connected to the second switch, and a second end of the inductor is electronically connected to the ground through the filter capacitor.

15. The power supply device as claimed in claim 14, wherein the first switch and the second switch are field-effect transistors, gate electrodes of the field-effect transistors are electronically connected to the controller; the controller is a pulse width modulation integrated circuit chip.

16. The power supply device as claimed in claim 15, wherein the input terminal is connected in parallel with the filter capacitor.

17. The power supply device as claimed in claim 10, wherein the logic module is communicated with the power supply unit through a serial data pin and a serial clock pin of a system management bus.
